(19) United States
(12) Patent Application Publication
(10) Pub. No.: US 2007/0152451 A1
(43) Pub. Date: Jul. 5, 2007

(54) Compact-sized generation of appreciable hydropower through centrifuge-induced gravity effects

(76) Inventor: Geraldo R. Iglesia, San Diego, CA (US)

Correspondence Address: NATH & ASSOCIATES PLLC, 112 South West Street, Alexandria, VA, 22314, US

(21) Appl. No.: 11/647,192

(22) Filed: Dec. 29, 2006

Related U.S. Application Data
(60) Provisional application No. 60/766,126, filed on Dec. 31, 2005.

(51) Int. Cl. F03B 13/00

(52) U.S. Cl. 290/54

(57) ABSTRACT

A device and a method for producing hydroelectric energy. The device generates compact-scale appreciable hydroelectric energy. Utilizing centrifugal force, at least one container attached to a radial arm moves horizontally about a vertical axis. Pressurized liquid in the container flows at high speed through a penstock into, and ultimately through, a turbine to generate electricity.

### CROSS-REFERENCE TO RELATED APPLICATIONS

This application claims benefit of U.S. provisional patent application Ser. No. 60/766,126, filed Dec. 31, 2005, the disclosure of which is hereby incorporated by reference in its entirety.

### FIELD OF THE INVENTION

The present invention relates generally to renewable energy. More particularly, the present invention relates to a device and method of generating appreciable hydroelectric energy.

### BACKGROUND OF THE INVENTION

Generation of energy is needed to support the world's growing population and economy. Energy demands are currently taxing the existing electrical energy supply. To meet the energy demand, there has been great interest in exploiting renewable energy resources, such as hydroelectric power.

Hydroelectric power is generated when kinetic energy is extracted from flowing water and used to rotate a turbine to produce electric power. Generally, large-scale hydroelectric power generation requires a water source such as a river, dam or reservoir.

Dams used in conventional hydroelectric power systems have been linked to negative physical, chemical and biological effects on the bodies of water to which these dams are disposed. These negative environmental effects manifest themselves in habitat destruction, obstructions to natural fish movement, poor water quality, over-harvest of natural resources and competition from non-indigenous species. Further, hydroelectric dams may degrade riverine habitat and impede movement of migratory fishes to and from their natal streams.

One common type of dam is a pumped storage dam. When two reservoirs exist at different elevations in the same general vicinity, a pumped-storage scheme is commonly used to store and produce hydroelectric energy for addressing high peak demands for electricity. At times of low electrical demand, excess electrical capacity is utilized to pump water into the higher reservoir. When there is higher demand, water is released back into the lower reservoir through a turbine, generating hydroelectricity. Because wholesale rates for electricity may be markedly lower during night time than during the day, a pumped-storage hydroelectric system tends to be an economically feasible alternative to traditional methods of generating hydroelectric power. However, due to evaporation losses from the exposed water surface and mechanical efficiency losses during conversion, only between 70 percent and 85 percent of the electrical energy used to pump the water into the elevated reservoir can be regained in the process.

In any hydroelectric energy generating system, the amount of electric power produced is basically proportional to the flow rate, unit weight of fluid (water), and available hydraulic head through the turbine(s). Thus, in order to maximize the power generated, major hydroelectric energy facilities have typically been constructed where high hydraulic head is available through natural (e.g., waterfalls) or manmade (e.g., dams/reservoirs) means. In smaller-scale applications, the energy from flowing rivers or streams has also been tapped for conversion to electricity.

In all these cases, the unit weight of the fluid (water) is taken for granted or is assumed not to change significantly during envisioned operational scenarios. This seemingly natural propensity to assume a uniform unit weight of fluid actually tends to overlook the fundamental concept of the unit weight as a function of both the mass density and acceleration due to gravity. Although the fluid mass density is essentially constant, the acceleration due to gravity can change, depending on the location, planet, or environment, such as in a centrifuge.

The application of centrifuge principles is prevalent in various fields of science and engineering. For example, in chemical and medical facilities, a centrifuge apparatus is generally used to induce separation between substances previously mixed in liquid solution, typically placed in laboratory test tubes. In the field of civil engineering, high-capacity centrifuges have commonly been used to perform model-scale testing of large-scale geotechnical systems in order to simulate the same level of stresses and pressures that would exist in the real-world condition.

Therefore a need exists for an improved device and method for the production of hydroelectric energy.

### SUMMARY OF THE INVENTION

The foregoing needs are met by the present invention, wherein, in one aspect, a compact-sized device for generating appreciable hydropower by taking advantage of high-gravity effects induced with a centrifuge apparatus is provided.

Borrowing from geotechnical modeling techniques, a miniature-scale replica of a typical real-world hydroelectric system comprising a reservoir, penstock, and turbine(s) can be built, to be mounted and spun in a centrifuge setting. The elevated gravitational field induced in the centrifuge setting will cause the fluid in the miniature-scale model to be heavily pressurized, potentially increasing the power that can be generated in this environment, even though the available hydraulic head appears small. The effluent fluid from the turbine(s) will be directed out of the high-gravity environment toward a central collection bin, where the fluid will be pumped up against normal gravity and redirected via a central feeder toward the reservoir in the spinning miniature model.

The high-gravity field in the miniature model will also increase the velocity at which the fluid will flow through the penstock toward the turbine(s), but the diameter sizes of the penstock and other conduits in this system can be designed and constructed such that the inflows and outflows can be regulated accordingly. The fluid levels in the “upper” reservoir (in the miniature model) and in the “lower” reservoir (in the central collection bin) will be monitored in conjunction with a feedback-loop mechanism, such that the centrifuge rotational speed and/or pumping rate can be adjusted as necessary.

This hydropower generating scheme is analogous to a pumped-storage system typically implemented with full-scale reservoirs, except that the proposed scheme seeks to exploit the favorable differences in prevailing gravitational acceleration fields provided by the centrifuge.

Therefore, in accordance with one embodiment of the present invention, a device having a central shaft is provided. The central shaft has an exterior surface. At least one radial arm having first and second ends are attached to the central shaft in a horizontal position. At least one container is attached to the first end of the radial arm. The container has at least one opening and at least one turbine in communication with a corresponding opening. Additionally, a central feeder is attached to the central shaft. Further, at least one penstock is connected to the central shaft. At least one horizontal conduit is attached to the central feeder. The horizontal conduit has an end that is positioned above a corresponding container. Also attached to the central feeder is a vertical conduit. A lower reservoir with a pump attached to an end of the vertical conduit is associated with the vertical conduit. At least one electrical slip ring is positioned on the exterior surface of the central shaft. The electrical slip ring is in electrical communication with each turbine. Also, an energy storage vessel is in electrical communication with the electrical slip ring. An external power source is attached to the central shaft.

In accordance with another embodiment of the present invention, a device having a central shaft with a top end and a bottom end and an exterior surface is provided. At least one radial arm is attached to the central shaft in a horizontal position. The radial arm has a first end and a second end. At least one container is attached to the first end of the radial arm. At least one additional container is attached to the second end of the radial arm. The first and second end containers each comprise at least one opening, at least one penstock attached to each opening and at least one turbine attached proximate to each penstock. A central feeder is attached to the bottom end of the central shaft. At least one horizontal conduit having a first end and a second end is attached to the central feeder. The first end of one horizontal conduit is positioned above the first container and the second end positioned above the additional container. Additionally, a vertical conduit is attached to the central feeder. A reservoir with a pump associated therewith is also provided and attached to an end of the vertical conduit.

There has thus been outlined certain embodiments of the invention in order that the detailed description thereof herein may be better understood, and in order that the present contribution to the art may be better appreciated. There are additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

At least one electrical slip ring is positioned on the exterior surface of the central shaft. The electrical slip ring is in electrical communication with one or more of the turbines. An energy storage vessel is in electrical communication with the electrical slip ring. An external power source is attached to the central shaft.

In an alternate embodiment of the present invention, a device having a central shaft having an exterior surface is provided. A central feeder is attached to the central shaft. At least one conduit having an end is attached to the central feeder. Additionally, at least one penstock is attached to the conduit. At least one turbine is attached to the end of the conduit. At least one electrical slip ring is positioned on the exterior surface of the central shaft. The electrical slip ring is in electrical communication with the turbine. An energy storage vessel is in electrical communication with the electrical slip ring. Further, a liquid source is attached to the central feeder. An external power source is attached to the central shaft.

In accordance with a further embodiment of the present invention, a method of producing energy is provided. According to the method, at least one container and a liquid are provided. The container comprises at least one opening and at least one turbine in communication with the a corresponding opening. A centrifuge supporting the container is operated. The container is filled with a liquid. The liquid is allowed to flow through the opening into, and ultimately through the turbine(s). Energy is extracted from each turbine. The steps of this, or any method, according to the present invention may be performed in any order.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 is a schematic view of the device according to an embodiment of the present invention;

FIG. 2 is a graphic representation of a device according to another embodiment of the present invention;

FIG. 3 is an operational view of the device according to FIG. 2.

### DETAILED DESCRIPTION

The invention will now be described with reference to the drawing figures, in which like reference numerals refer to like parts throughout.

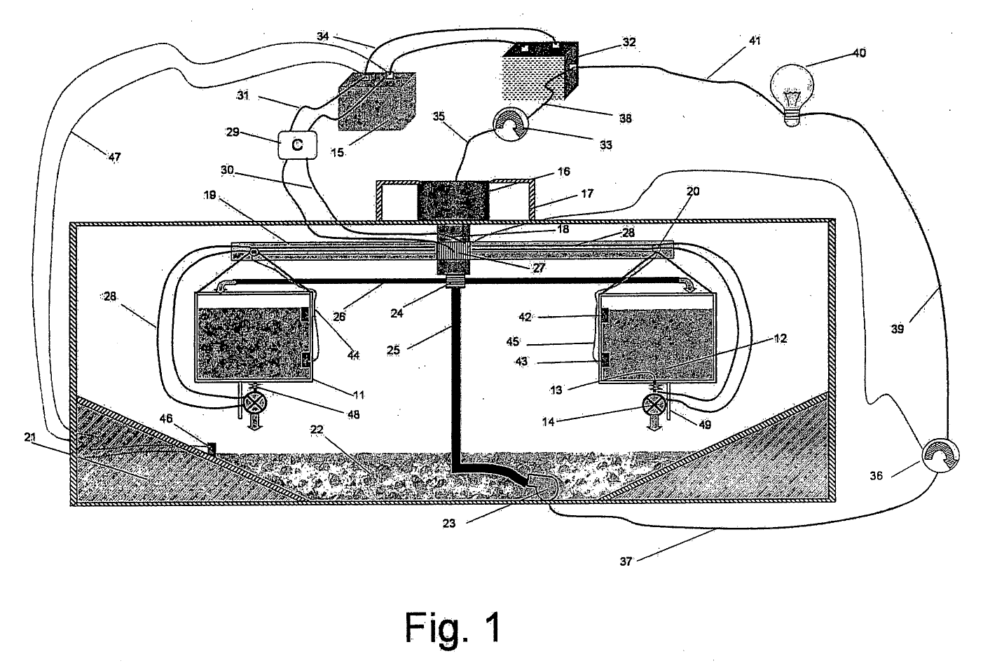

With reference to FIG. 1, shown is a view of the device according to an embodiment of the present invention. The device shown has an upper reservoir 12 and a lower reservoir 22. The upper reservoir 12 is formed by filling an upper container 11 with a liquid. The liquid could be any liquid, including water. The upper container 11 has an opening with a release valve 48 proximate thereto. With the release valve 48 open, fluid discharges out from the upper reservoir 12, through a penstock 13 and turbine/generator 14, into a lower container 21 holding a lower reservoir 22.

The turbine/generator 14 includes conventional components (not shown), such as blades, rotating element(s), windings, and magnet(s), to transform the energy of flowing liquid into rotational energy and eventually into electrical energy. The turbine can be any type of turbine including, for example, a Francis turbine, Kaplan turbine, Propellerturbine, Bulb turbine, Tube turbine, Straflo turbine, Tyson turbine, or water wheel turbine. Alternatively, the turbine can be an impulse turbine such as, a Pelton turbine, Turgo turbine, and Michell-Banki turbine (also known as the crossflow or Ossberger turbine).

A pump 23, in the lower reservoir 22 helps bring the liquid back into the upper reservoir 12 through a vertical conduit 25 and horizontal conduit 26, via a central feeder 24. This process can be repeated accordingly.

The pump 23 can be any type of pump. It can be operated electrically, by manual manipulation, or the like. The pump 23 can work at a constant rate or at a variable speed. The conduits 25 and 26 can be any type of channel, pipe, or the like, capable of allowing a liquid to flow from one location to the next. The conduits can be formed from any material including, metals, plastics, rubbers, natural material, synthetic material, or any combination thereof. The central feeder 24 can be any type of connector capable of receiving the vertical conduit 25 and horizontal conduit 26. For example, the central feeder 24 can be a swiveling pipe joint. In addition, the upper container 11 can be any size or shape capable of forming a reservoir 12.

By securely suspending an upper container 11 at the end of a relatively long radial arm 19 that can spin around a vertical axis 18 such that the container 11 swings outward as the radial arm 19 rotates, the upper reservoir 12 can effectively be subjected to an elevated gravity field due to centrifugal inertia. Since the energy input to a pump or output from a turbine is proportional to the ambient gravitational acceleration, the fact that the lower reservoir 22 remains outside the influence of the elevated gravity field leads to a rather favorable energy situation, notwithstanding the additional energy requirement for spinning the upper reservoir. For purposes of this invention, an upper reservoir may include any element attachable to the upper container 11, either directly or indirectly, with the exception of the radial arm 26.

As shown, the device has two identical upper containers 11 attached to radial arm 19. In alternative embodiments the upper containers 11 can be attached directly to the horizontal conduit 26. Additionally, more than one radial arm 19 may be provided in alternative embodiments. The radial arm 19 can be formed from any material including plastics, rubbers, polymers, synthetic material, and natural materials. Further, the upper containers 11 can be attached by any connector, such as a chain, string, or the like. The upper container 11 is attached to the radial arm 19 at a freely rotating support and connector 20.

In further alternative embodiments, the device can operate with a single, or multiple, containers 11 provided that a counterweight or force allows the device to accelerate to a point that a centrifugal force acts upon the container 11. If the radial arm 19 extends beyond two sides of the central feeder 18, suspending equal masses at the ends of the radial arm 19 will balance the arm, thereby improving efficiency. Therefore, more than two packages capable of producing energy may be installed and balanced around the vertical axis 18 as the system capacities and space constraints allow.

Additionally, the diameter sizes of the penstocks 13 and the conduits 25 and 26 are designed and constructed such that the inflows and outflows can be regulated accordingly. Further, a fluid-level-monitoring system can regulate the amount of liquid available to the upper/bucket container 11. The fluid-level-monitoring system monitors the high-water and low-water levels in the upper containers 11 using a high water sensor 42 and a low water sensor 43, respectively, during system operation. Depending on the level of liquid in the upper container, the centrifuge rotational speed about the central axis 18 and/or the pumping rate from the lower reservoir 22 can be adjusted manually or automatically using programmable logic controllers such as a rotational speed controller 33 and a pumping rate controller 36. The level of the lower reservoir 22 will also need to be monitored through sensor 46, to determine if additional liquid is required for the hydropower generation system due to evaporation or other losses.

Electrical communication between the elements of the present invention may be achieved with wires. A number of wires are shown in FIG.1. For example: there is wire 30 extending between the electrical slip ring 27 and the charge control controller/regulator 29; a wire 31 extends between the charge controller/regulator 29 and the external energy source 15; a wire 34 extends between the external energy source 15 and the power inverter 32; a wire 35 extends between the rotational speed controller 33 and the motor 16; a wire 37 extends between the pumping rate controller 36 and the pump 23; a wire 38 extends between the external energy source 15 and the rotational speed controller 33; a wire 39 extends between the electrical energy source 15 and the pumping rate controller 33; a wire 41 extends between the power inverter 32 to the electrical load 40; a wire 44 extends between the high-water-level sensor in the upper reservoir 42 and the electric slip ring 27; a wire 45 extends between the low-water-level sensor 43 and the lower reservoir 22; and a wire 47 extends between the external energy source 15 to the water-level sensor in the lower reservoir 46. As the skilled artisan would realize, the device may be wired in a number of non-limiting manners.

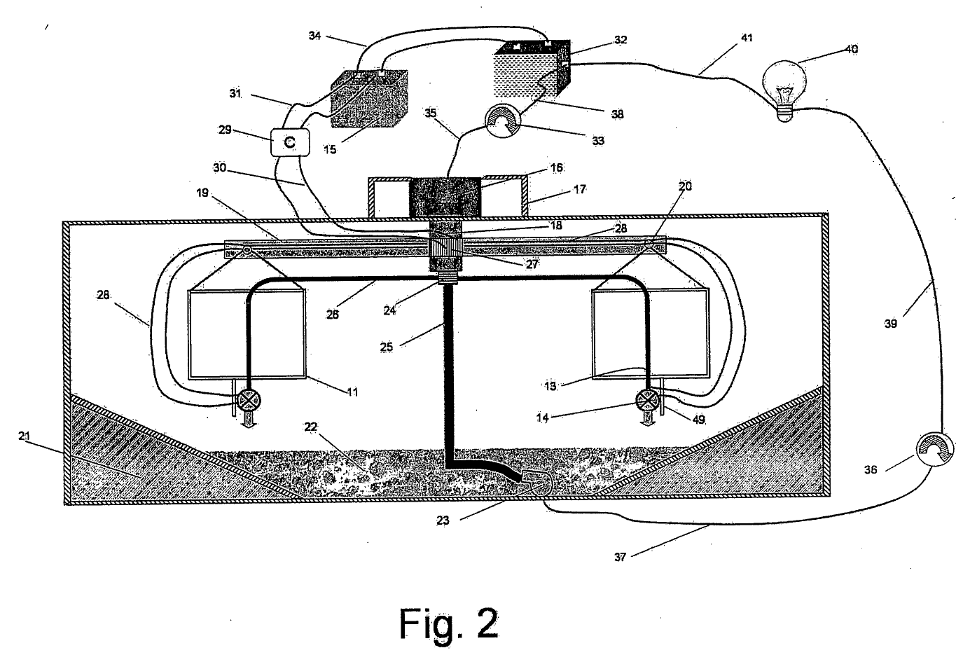

Turning now to FIG. 2, shown is a graphic representation of a device according to another embodiment of the present invention. According to the device of FIG. 2, the need for an upper reservoir 12 may be eliminated by extending the length of the vertical conduit 25 preceding the turbine/generator 14. According to the embodiment shown, the penstock 13 is connected directly to the central feeder 24. This embodiment also eliminates the need for a feedback-loop mechanism to monitor the upper reservoir 12 fluid levels, while still tapping the power-generating potential of a pressurized fluid flowing continuously at high speeds and discharge rates induced in a centrifuge environment.

Besides the induced elevated pseudo-gravitational field, a desirable and derivable effect of this centrifuge-based invention is the continuously flowing effluent fluid through the penstock 13 and turbine 14 at discharge rates much higher than when otherwise placed under normal gravity. According to the embodiment of the present invention shown in FIG. 2, the need for an “upper” reservoir storage and a fluid-level-monitoring mechanism is eliminated by essentially connecting the penstock 13 directly to the central feeder 24, while still retaining the ability to convert the kinetic energy of the rapidly flowing pressurized fluid (by centrifugal action) into electrical energy via the turbine 14.

As shown, primarily for balancing purposes, suspending a mass at one end of the radial arm 19 requires the same mass or an equivalent force acting opposite to the mass be at the other end. As suggested, more than two packages capable of producing energy may be installed and balanced around the vertical axis 18 as the system capacities and space constraints allow.

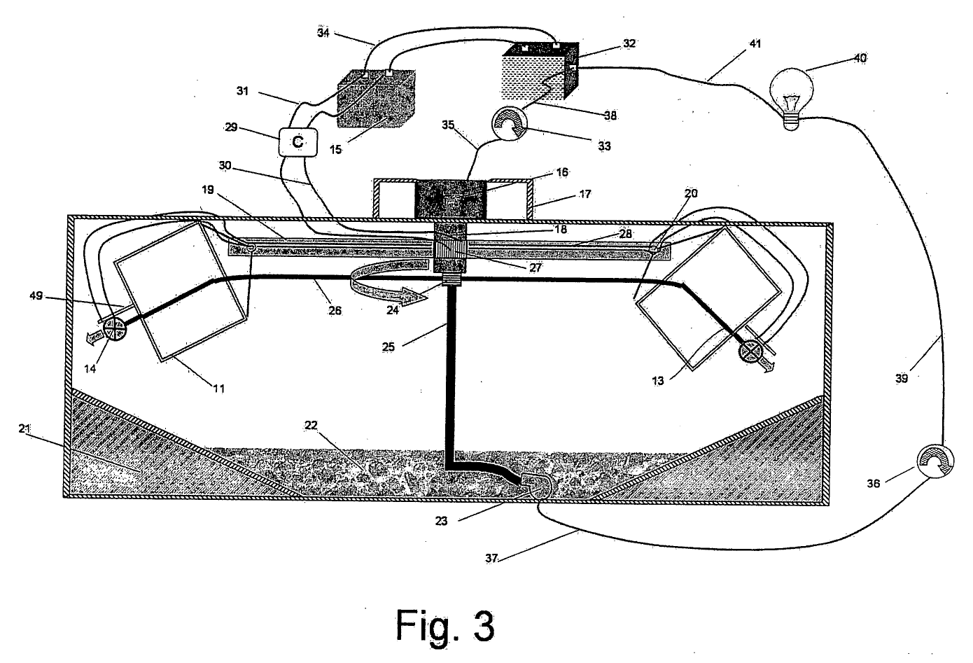

Referring now to FIG. 3, shown is an operational view of the device according to FIG. 2 a motor 16 powered by an external energy source 15, possibly through a power inverter 32, drives the central shaft 18, rotating the radial arm 19 of a centrifuge system about the vertical axis of the central shaft 18. A mount for motor 17 is attached to the motor for support. The external energy source can be rechargeable. Accordingly, the external energy source 15 is also referred to as the external energy storage or as an energy storage vessel. The external energy source/storage 15 can be any source capable of providing and receiving energy, such as a rechargeable battery.

As the radial arms 19 rotate about the vertical axis of the central shaft 18, the securely suspended upper containers 11 swing radially outward along with any attached components, such as the penstocks 13 and turbines 14. In such configuration, fluid discharging through the penstocks 13 and turbines 14 will tend to generate greater energy than under normal gravity, depending on the centrifuge speed of rotation about the central axis 18.

The effluent fluid from the turbines 14 is directed out of the high-gravity environment of the upper buckets 11 toward the centrally located lower reservoir 22. The pump 23, which is powered either directly by the external energy source 15 or through the power inverter 32, causes the liquid to flow upward against normal gravity from the lower reservoir 22 through the central conduit 25. With the use of the central feeder 24, the liquid can be redirected back through the penstocks 13 and to the turbines 14, where the flow cycle ends and begins anew.

Electricity generated from the turbines 14 can be used to recharge the electrical energy storage (e.g., battery, or the like) unit 15 by directing the current to flow via appropriate wirings 28, 30, and 31 through an electrical slip ring connection 27 that is concentrically positioned with the central shaft 18. A charge regulator 29 is installed to monitor the charge status of the electrical energy storage unit 15, and to ensure that the electrical energy storage unit 15 is not overcharged. The electrical energy storage unit 15 can then be tapped to power the electrical components in the system and possibly other external electrical loads 40.

The diameter sizes of the penstocks 13 and the conduits 25 and 26 are designed and constructed such that the inflows and outflows can be regulated accordingly. The level of the lower reservoir 22 may need to be monitored to determine if additional liquid is required for the hydropower generation system due to evaporation or other losses.

The present invention is also drawn to various methods for using the devices for producing hydroelectric energy disclosed herein.

In accordance with a further embodiment of the present invention, a method of producing energy is provided. According to the method at least one container and a liquid are provided. At least one container comprises at least one opening and at least one turbine in communication with at least one opening. A centrifuge supporting at least one container is operated. Each container is filled with a liquid. The liquid is allowed to flow through each opening into, and ultimately through each turbine. Energy is extracted from each turbine. The steps of this, or any method, according to the present invention may be performed in any order.

In another step, the electricity produced by the device can be transmitted to an energy storage vessel. Further, the electricity from the energy storage vessel may be transmitted to an external load. Additionally a constant amount of liquid may be maintained in each container.

According to an additional embodiment of the present invention, at least one additional container is provided. Similarly to the first container, each additional container comprises at least one opening and at least one turbine attached to each opening. Each additional container is filled with a liquid. The liquid is allowed to flow each opening into, and through each corresponding turbine while operating the centrifuge. Energy is extracted from each turbine. Additionally, a constant amount of liquid is maintained in each container.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A device, comprising:
a central shaft having an exterior surface;
at least one radial arm having first and second ends and being attached to the central shaft in a horizontal position;
at least one container attached to the first end of the radial arm and comprising at least one opening and at least one turbine in communication with each opening;
a central feeder attached to the central shaft;
at least one penstock connected to the central shaft;
at least one horizontal conduit attached to the central feeder and having an end thereof positioned above the at least one container;
a vertical conduit attached to the central feeder;
a lower reservoir with a pump associated therewith, the pump being attached to an end of the vertical conduit;
at least one electrical slip ring positioned on the exterior surface of the central shaft, wherein the at least one electrical slip ring is in electrical communication with each turbine;
an energy storage vessel in electrical communication with the electrical slip ring;
an external power source attached to the central shaft.

2. The device of claim 1, further comprising at least one additional container attached to the second end of the radial arm and comprising at least one opening and at least one turbine in communication with each opening.

3. The device of claim 2, wherein a second end of the at least one horizontal conduit is positioned above the at least one additional container.

4. The device of claim 1, wherein the central feeder further comprises a swiveling pipe joint.

5. The device of claim 1, wherein the penstock further comprises a release valve.

6. The device of claim 1, wherein the lower reservoir further comprises a water-level sensor.

7. The device of claim 1, wherein the at least one container further comprises a high water level sensor and/or a low water level sensor.

8. The device of claim 1, wherein the at least one container further comprises a bracket support attached to each turbine.

9. The device of claim 1, wherein the at least one penstock is located at the connection between the vertical conduit and the central feeder.

10. The device of claim 1, wherein the at least one penstock is located in the vertical conduit.

11. The device of claim 1, wherein the at least one penstock is located in the horizontal conduit.

12. A device, comprising:
a central shaft having a top end and a bottom end and an exterior surface;
at least one radial arm attached to the central shaft in a horizontal position, each radial arm having a first end and a second end;
at least one first container attached to the first end of the radial arm;
at least one additional container attached to the second end of the radial arm, each container comprising at least one opening, at least one penstock attached at each opening and at least one turbine attached proximate to each penstock;
a central feeder attached to the bottom end of the central shaft;
at least one horizontal conduit attached to the central feeder, each horizontal conduit having a first end and a second end, the first end positioned above the at least one first container and the second end positioned above the at least one additional container;
a vertical conduit attached to the central feeder;
a reservoir with a pump associated therewith, the pump being attached to an end of the vertical conduit;
at least one electrical slip ring positioned on the exterior surface of the central shaft and being in electrical communication with each turbine;
an energy storage vessel in electrical communication with the electrical slip ring;
an external power source attached to the central shaft.

13. A method of producing energy, comprising:
providing at least one container and a liquid, each container comprising at least one opening and at least one turbine in communication with each opening;
operating a centrifuge supporting each container;
filling each container with the liquid;
allowing the liquid to flow through each opening into, and through, each turbine; and
extracting energy from each turbine.

14. The method according to claim 13, further comprising providing at least one additional container comprising at least one opening and at least one turbine attached to each opening;
filling each additional container with the liquid;
allowing the liquid to flow through each opening into, and through, each turbine while operating the centrifuge; and
extracting energy from each turbine.

15. The method according to claim 13, further comprising transmitting the electricity to an energy storage vessel.

16. The method according to claim 15, further comprising transmitting the electricity from the energy storage vessel to an external load.

17. The method according to claim 13, further comprising maintaining a constant amount of liquid in the at least one container.

18. The method to claim 14, further comprising maintaining a constant amount of liquid in the at least one additional container.

19. A device, comprising:
a central shaft having an exterior surface;
a central feeder attached to the central shaft;
at least one conduit having an end attached to the central feeder;
at least one penstock attached to the at least one conduit;
at least one turbine attached to the end of each conduit.
at least one electrical slip ring positioned on the exterior surface of the central shaft, wherein the at least one electrical slip ring is in electrical communication with each turbine;
an energy storage vessel in electrical communication with the electrical slip ring;
a liquid source attached to the central feeder; and
an external power source attached to the central shaft.
